(19) United States
(12) Patent Application Publication
(10) Pub. No.: US 2015/0247457 A1
(43) Pub. Date: Sep. 3, 2015

(54) EXHAUST SYSTEM COMPONENT

(71) Applicant: Whitesell International Corporation, Waterford, MI (US)

(72) Inventor: Randy M. Hoffman, South Lyon, MI (US)

(73) Assignee: Whitesell International Corporation, Waterford, MI (US)

(21) Appl. No.: 14/193,469

(22) Filed: Feb. 28, 2014

(51) Int. Cl. F02C 7/00

(52) U.S. Cl. CPC F02C 7/00

(57) ABSTRACT

An internal combustion engine exhaust system component includes an exhaust gas conduit having a metal shell. A boss is crimped to the metal shell. The boss is to threadingly mount an electrical sensor to measure an exhaust gas property. The boss includes a self-attaching nut.

### BACKGROUND

Some internal combustion engine systems include an electrical sensor mounted inside the exhaust system to measure how well combustion occurs in the engine. An amount of fuel allowed into the engine may be controlled by the engine's fuel injection circuits or ECU (Electronic Control Unit). The sensor allows the engine ECU to adjust the amount of fuel sent to the engine for fuel economy and reduced exhaust emissions. Many names are used with reference to such an electrical sensor. For example: EGO sensor (Exhaust Gas Oxygen Sensor); HEGO sensor (Heated Exhaust Gas Oxygen Sensor); Oxygen Sensor/O2 sensor (the sensor measures the Oxygen present in the exhaust gas stream); “Planar” or “Wideband” sensor (a revised version of the sensor to meet different emissions requirements); and Lambda sensor. The word “probe” may be substituted for “sensor” e.g. “Lambda Probe”. In some cases the word “sonde” is used in place of the word “sensor”, e.g. “Lambda Sonde”. In the present disclosure, the term HEGO sensor will be used, however, it is to be understood that any sensor that measures hot internal combustion engine exhaust gases could be used.

### SUMMARY

An internal combustion engine exhaust system component includes an exhaust gas conduit having a metal shell. A boss is crimped to the metal shell. The boss is to threadingly mount an electrical sensor to measure an exhaust gas property. The boss includes a self-attaching nut.

### BRIEF DESCRIPTION OF THE DRAWINGS

Features and advantages of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a side view of a Heated Exhaust Gas Oxygen (HEGO) sensor according to an example of the present disclosure;

FIG. 2 is a perspective view of a catalytic converter and a tubular member, each with a boss crimped thereto to threadingly mount a HEGO sensor according to an example of the present disclosure;

FIG. 3 is a perspective view of a flat land on a tubular member according to an example of the present disclosure;

FIG. 4 is a perspective view depicting a HEGO sensor aligned with a self-attaching boss prior to mounting the HEGO sensor on the boss according to an example of the present disclosure;

FIG. 5 is a perspective view of an example of a self-attaching boss according to the present invention;

FIG. 6 is a top view of the self-attaching boss shown in FIG. 5;

FIG. 7 is a cross-sectional view through line 7-7 of FIG. 6;

FIG. 8 is a cross-sectional view through line 8-8 of FIG. 6;

FIG. 9 is an expanded view of one anti-rotational feature marked in circle 9 in FIG. 7;

FIG. 10 is an expanded view of another anti-rotational feature marked in circle 10 of FIG. 8;

FIG. 11 is a perspective view of another example of a self-attaching boss having an octagonal outer wall;

FIG. 12 is a plan view of the self-attaching boss depicted in FIG. 11;

FIG. 13 is a partial sectional view of the central pilot portion of an example of a self-attaching boss according to the present disclosure;

FIGS. 14A-14C depict a process for installing a self-attaching boss according to an example of the present disclosure;

FIG. 15 is a side view of a self-attaching boss shown in FIG. 9 with a die button aligned in an installation apparatus, ready for installation in a metal shell according to an example of the present disclosure;

FIG. 16 is a side cross-sectional view of the elements depicted in FIG. 15 depicted during installation of the self-attaching boss in the metal shell;

FIG. 17 is a partial side cross-sectional view of the elements depicted in FIG. 16 with a detailed view of the engagement of an example of the clinching lip and the metal shell; and

FIG. 18 is a partial side cross-sectional view of the elements depicted in FIG. 16 with a detailed view of the engagement of another example of a clinching lip and the metal shell.

### DETAILED DESCRIPTION

In an internal combustion (IC) engine, the combustion of a fuel occurs with an oxidizer in a combustion chamber. In an IC engine, expansion of high-temperature and high-pressure gases produced by combustion apply direct force to some component of the engine. For example, the force may be applied typically to pistons, turbine blades, or a nozzle. This force moves the component over a distance, transforming chemical energy into useful mechanical energy. The gas products of combustion are called “exhaust gases”. The exhaust gases may be routed away from the IC engine through an exhaust system that may chemically transform the exhaust gases to other gases before emission into the environment. Exhaust gases that immediately exit the engine may be called “feed gas”. Feed gas is an exhaust gas mixture that is fed into the exhaust system. Properties of the exhaust gases may be used to control the IC engine to improve fuel economy and reduce the emission of certain gases and particulate matter into the atmosphere.

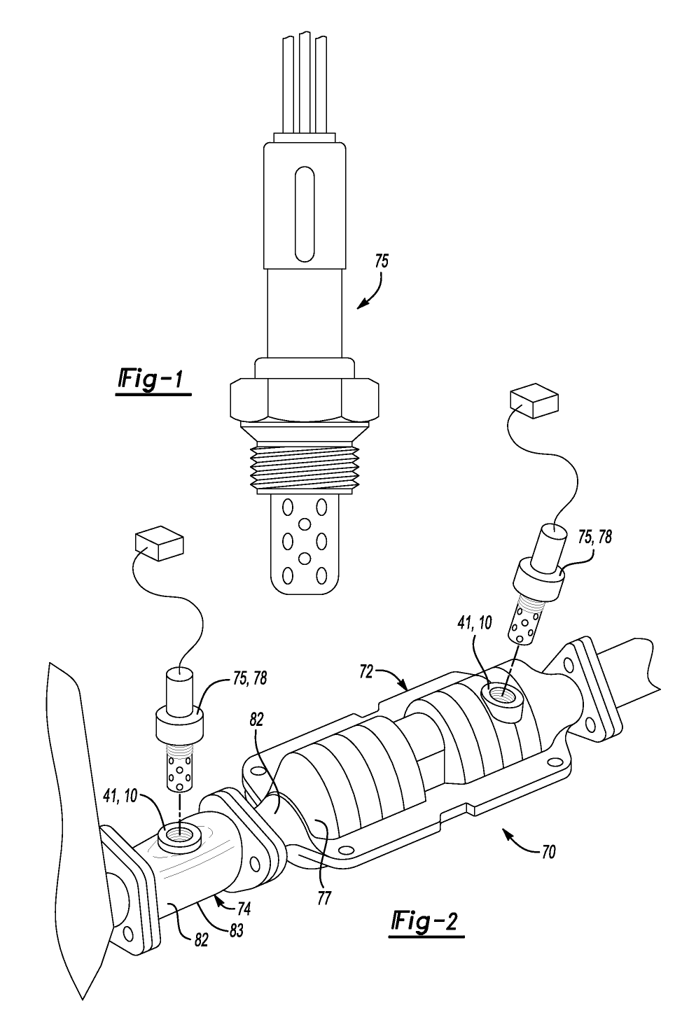

One property of exhaust gases that is useful in IC engine control is the amount of oxygen present in the exhaust gas. A HEGO sensor may be used to measure the amount of oxygen present in the exhaust gas. An example of a HEGO sensor 75 is depicted in FIG. 1. In some exhaust systems, a HEGO sensor may be disposed in the exhaust system upstream of a catalytic converter, downstream of the catalytic converter, or both upstream and downstream of the catalytic converter. In some exhaust systems, a HEGO sensor may be mounted between catalytic elements of a catalytic converter. The exhaust gases encountered by HEGO sensors may be at relatively high temperatures that heat the exhaust tubes and catalytic converter. Exhaust system components therefore are subjected to relatively rapid changes in temperature after a cold start. Since the exhaust system components experience relatively rapid changes in temperature, the exhaust system components also experience relatively rapid thermal expansion. Eventually, the exhaust system components cool to ambient temperature when the engine is turned off. The thermal expansion and contraction (strain) of the exhaust system components contribute to thermal stress.

Some HEGO sensors are configured to be replaceable in an exhaust system. A HEGO sensor may be threaded into a wall of an exhaust system component. The walls of some exhaust system components are too thin to provide enough thread engagement for secure and long lasting attachment of the HEGO sensor to the exhaust system components. In some exhaust system components, a boss is welded to a wall of the exhaust system component. Various types of gas shielded arc welding have been used to attach a HEGO boss to a wall of an exhaust system component. Other welding methods may also be used, e.g., friction welding. Care must be taken to avoid warping the boss during welding. Some assembly line production processes have secondary operations to compensate for warping and to ensure a leak-tight fit between the HEGO sensor and the boss. An example of a secondary operation is tapping or retapping a threaded bore in the boss after welding. Another example is machining or grinding a face of the boss for flatness. Welding may introduce weld spatter into/onto machinery near welding operations. Certain welding methods may require the undertaking of certain measures to protect eyes and cameras from the intensity of light emitted during welding. Welding may release noxious fumes and temporarily elevate the temperature of components.

Welding is used for attachment of the HEGO boss on some existing exhaust systems because the high temperatures experienced by the exhaust system may tend to make the torque required to remove the HEGO sensor relatively high after years of service. Bosses attached by welding may have a strong boss-wall joint that seals well against the pressure of exhaust gases in the exhaust system.

It is believed that prior to the present disclosure, only welding has been used to attach a separate HEGO sensor boss to an exhaust system component. It is further believed that concerns about the ability of the boss to establish a long lasting, leak-tight seal, and maintain resistance to removal torques of HEGO sensors after years of service have prevented consideration of a self-attaching boss for HEGO sensor mounting on an exhaust system. However, contrary to the established practice of the industry, the inventors of the present disclosure have unexpectedly and fortuitously discovered that an exhaust system component with a boss having the characteristics disclosed herein may meet strength, durability, and leaktightness demands while providing manufacturing advantages over exhaust system components with welded-on HEGO bosses.

In examples of the present disclosure, an internal combustion engine exhaust system component includes an exhaust gas conduit having a metal shell and a boss crimped to the metal shell. The boss is to threadingly mount an electrical sensor to measure an exhaust gas property. The boss may be a self-attaching nut, or at least include a self-attaching nut. As used herein, a self-attaching boss means a boss that is a self-attaching nut.

In the example of the present disclosure depicted in FIG. 2, the exhaust gas conduit 70 includes a catalytic converter 72 and a tubular member 74, each having a metal shell 82. The catalytic converter 72 is an exhaust gas conduit 70, and the tubular member 74 is also an exhaust gas conduit 70. Some examples of the present disclosure may have a single HEGO sensor 75 mounted on a tubular member 74 connected to the catalytic converter 72 as depicted in FIG. 4. The tubular member 74 may be connected to the catalytic converter 72 to convey an exhaust gas produced by the IC engine to the catalytic converter 72 or to convey the exhaust gas from the catalytic converter 72. The metal shell 82 of the tubular member 74 is the tubular wall 83. The metal shell 82 of the catalytic converter 72 is the metal wall that encloses an element that has a catalyst established thereon (not shown). The metal shell 82 may be, for example, formed from stainless steel. The metal shell 82 of the catalytic converter 72 should not be confused with a heat shield 77 that may be disposed to surround the metal shell 82 and present a lower surface temperature.

In examples of the present disclosure, the boss 41 is crimped to the metal shell 82. The boss 41 is to threadingly mount an electrical sensor 78 to measure an exhaust gas property. In the example depicted in FIG. 2, the boss 41 is a self-attaching nut 10, and the electrical sensor 78 is a HEGO sensor 75. The exhaust gas property in the example depicted in FIG. 2 is the amount of oxygen present in the exhaust gas at the HEGO sensor 75 location.

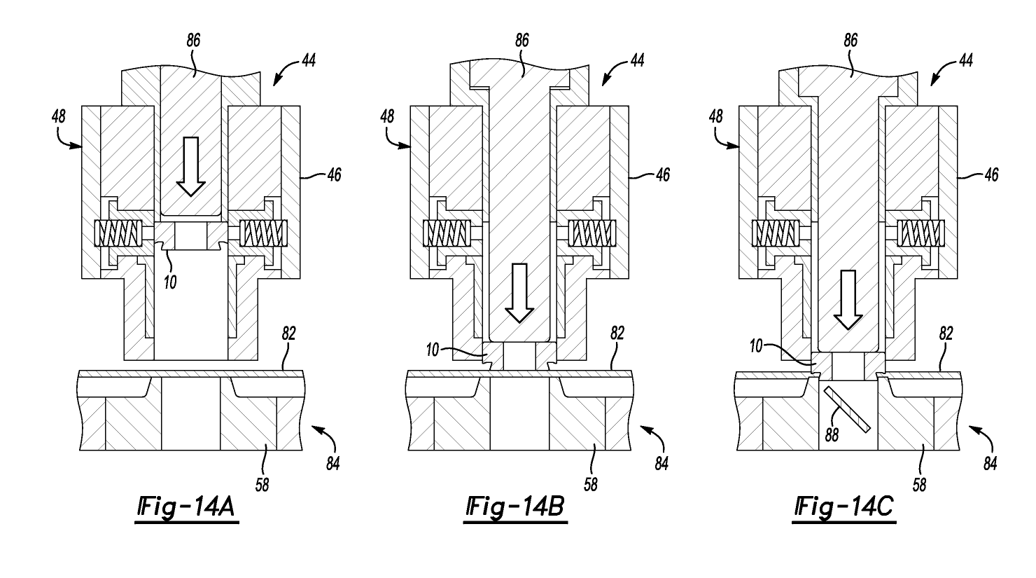

In examples of the present disclosure, the boss 41 may be a self-attaching nut 10, or at least include a self-attaching nut 10. As used herein, “boss” means a protuberant body attached to or projecting from another body for attachment of a third body. The self-attaching nut 10 of the present disclosure may be more specifically defined as a pierce nut or a clinch nut. The self-attaching nut 10 includes a bore, and the self-attaching nut 10 may be permanently installed in the metal shell 82 using a die press 44 (see FIGS. 14A-14C). The boss 41 is for attachment of the electrical sensor 78 to the metal shell 82 by threading the electrical sensor 78 into the bore of the self-attaching nut 10 to secure the electrical sensor 78 to the metal shell 82.

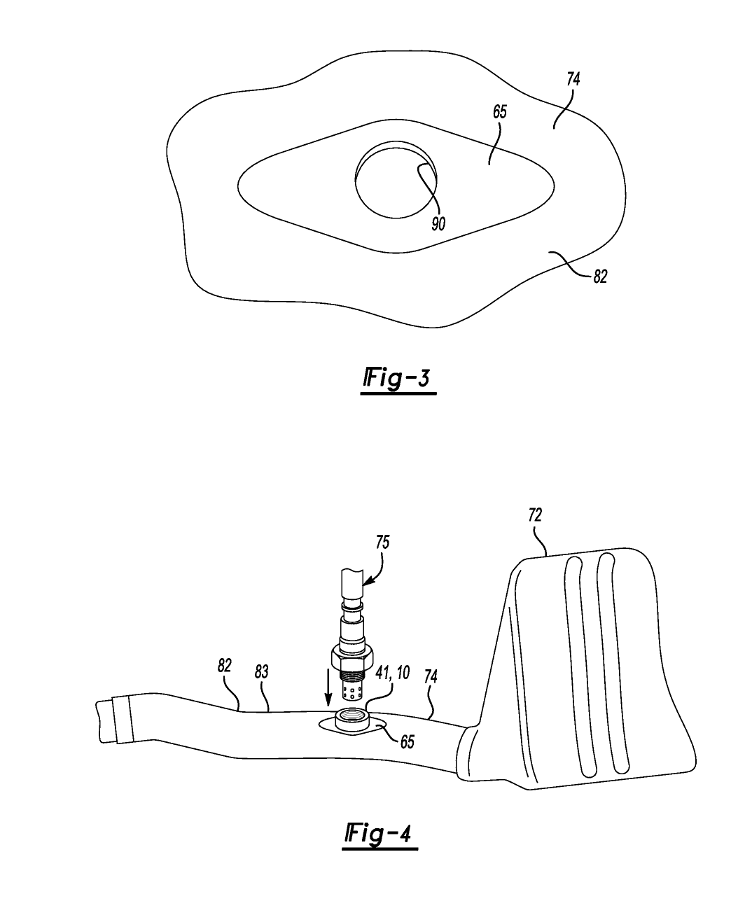

FIG. 3 is a perspective view of a flat land 65 defining an aperture 90 on a tubular member 74 according to the present disclosure. In an example of the present disclosure, the exhaust gas conduit 70 may have a generally curved cross-section perpendicular to the flow of the exhaust gases. For example, the catalytic converter 72 may have an oval cross-section, or the tubular member 74 may have a circular cross-section. A flat land 65 may be defined on the metal shell 82 to present a flat surface for engagement with the self-attaching nut 10. The flat land 65 may be formed by any suitable method, for example, the flat land 65 may be coined into the metal shell 82.

FIG. 4 is a perspective view depicting a HEGO sensor 75 aligned with a boss 41 prior to mounting the HEGO sensor 75 on the boss 41 according to the present disclosure. In the example depicted in FIG. 4, the boss 41 is a self-attaching nut 10 installed on a flat land 65 formed on the tubular member 74 according to the present disclosure.

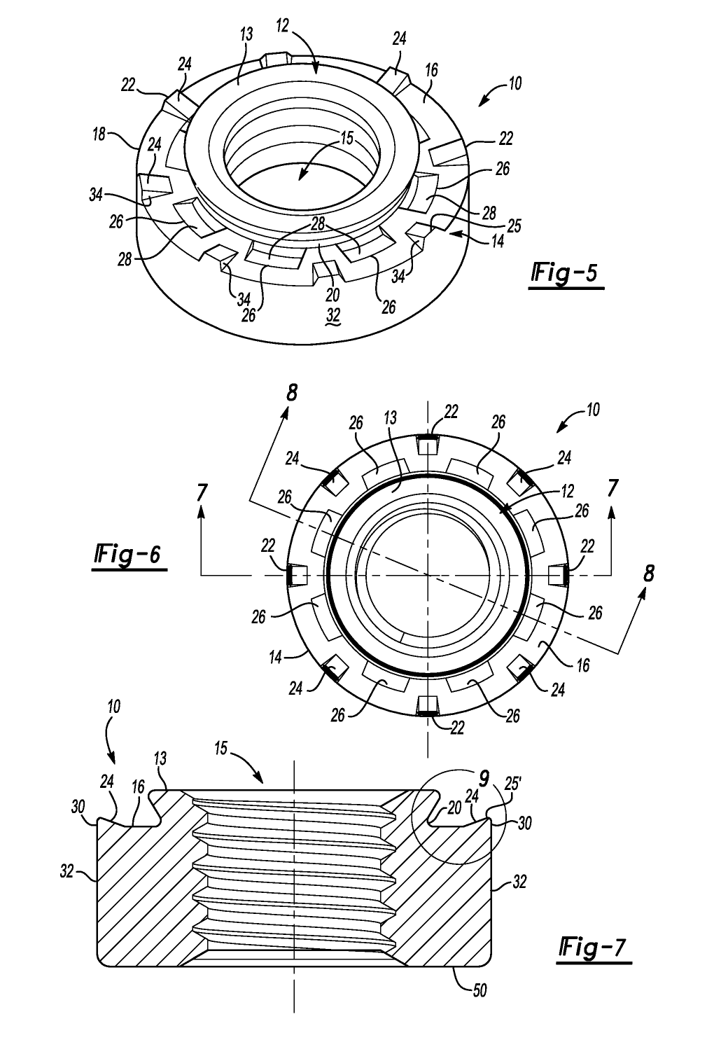

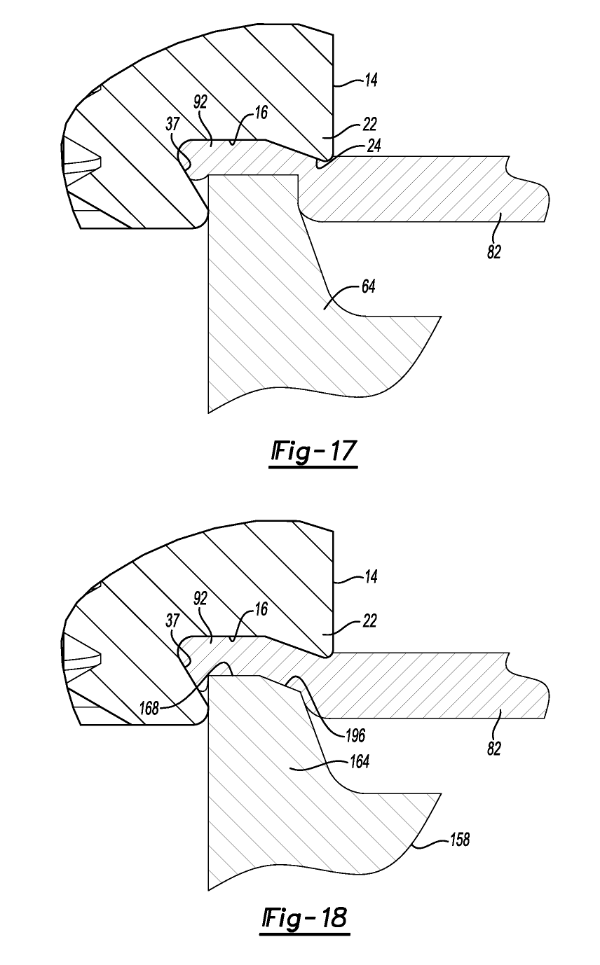

A self-attaching nut 10 that may be a boss 41 of the present disclosure is generally shown in FIG. 5. The self-attaching nut 10 represented in FIG. 5 may be a pierce nut or a clinch nut. In examples wherein the self-attaching nut 10 is a pierce nut, a central pilot portion 12 pierces an aperture 90 through the metal shell (see e.g. FIG. 14C and FIG. 16). In other examples, if the self-attaching nut 10 is a clinch nut, the central pilot portion 12 is inserted through a pre-pierced hole.

Still referring to FIG. 5, an annular flange 14 surrounds the central pilot portion 12 and has a generally planar end face 16 defining a peripheral edge 18. The central pilot portion 12 terminates at a pilot end 13 that is also generally planar and substantially parallel to the generally planar end face 16. The central pilot portion 12 defines a bore 15 that is threaded or un-threaded depending upon the electrical sensor 78 to be installed therein. For example, some HEGO sensors have a standard ANSI (American National Standards Institute) or ISO (International Organization for Standardization) M18x1.5 thread. In another example, the electrical sensor 78 may have self-tapping threads. The peripheral edge 18 of the annular flange 14 includes an edge diameter that is greater than a wall diameter of the outer side wall 20 of the central pilot portion 12 and is therefore extended radially outwardly from the central pilot portion 12.

A plurality of first anti-rotation elements 22 are circumferentially spaced around the planar end face 16. Each of the first anti-rotation elements 22 includes a first top face 24 that is planar that extends above the planar end face 16 of the annular flange 14. A plurality of second anti-rotation elements 26 is also circumferentially spaced around the planar end face 16 of the annular flange 14. Each of the second anti-rotation elements 26 includes a planar second top face 28 that is spaced below the planar end face 16 of the annular flange 14. It is to be understood that the terms “above” and “below” as used herein describe relative location as depicted in the relevant figure (for example, FIG. 5 is relevant to this paragraph), and do not convey a limitation on the orientation of the self-attaching nut 10 as a whole.

As represented in FIG. 5 and FIG. 6, the first anti-rotation elements 22 and the second anti-rotation elements 26 alternate in a circumferentially spaced relationship around the central pilot portion 12. Each of the first anti-rotation elements 22 extends from the peripheral edge 18 of the annular flange 14 to a location that is spaced from the outer side wall 20 of the central pilot portion 12. Each of the second anti-rotation elements 26 extends from about the outer side wall 20 of the central pilot portion 12 to a location that is spaced from the peripheral edge 18. Each of the first and second anti-rotation elements 22, 26 assists driving the metal shell 82 radially inwardly toward the central pilot portion 12 during installation/clinching onto the metal shell 82. This increases the amount of metal shell material disposed beneath the undercut 37 defined by the inclined surface 36 of the central pilot portion 12.

Referring to FIG. 7, the self-attaching nut 10 has a back face 50 distal to the pilot end 13. The back face 50 may be substantially planar as shown, or the back face 50 may have features to lock the electrical sensor 78 in place, or enhance sealing of the electrical sensor 78. For example, knurls or a washer face may be defined on the back face 50. The electrical sensor 78 may be installed through the back face 50.

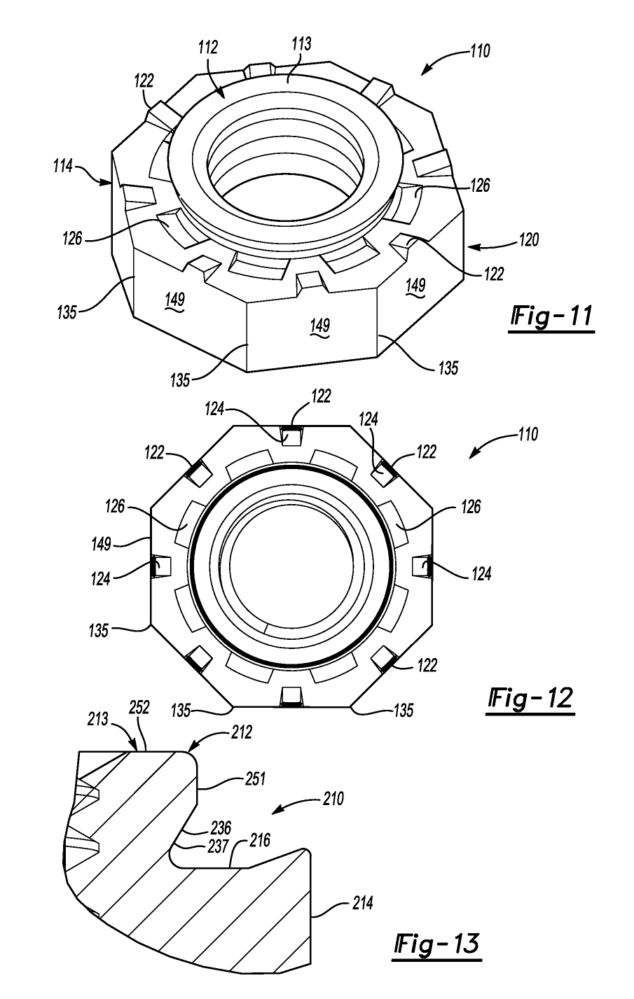

In an example of the present disclosure, the first anti-rotation elements 22 each extend radially inwardly toward the central pilot portion 12 from about the peripheral edge 18 of the planar end face 16. As shown in FIGS. 7 and 9, each first anti-rotation element 22 defines a distal wall 30 that is aligned with the outer radial flange wall 32 of the annular flange 14. In the previous sentence, the distal wall 30 being aligned with the outer radial flange wall 32 means that the distal wall 30 is a continuation of the outer radial flange wall 32. In examples wherein the outer radial flange wall 32 is cylindrical, the distal wall 30 is also cylindrical with the same axis and diameter as the outer radial flange wall 32. In examples wherein the outer radial flange wall 32 is an outer side wall 120 defined by a plurality of flange walls 149 that are generally planar (see, e.g., FIG. 11 at 149) a distal wall 30 being aligned with the outer radial flange wall 32 means that the distal wall 30 is coplanar with a respective flange wall 149. The leading edge 25, 25′ where the first top face 24 meets the distal wall 30 may be sharp as shown in FIG. 5 at 25, or the leading edge 25′ may be rounded as shown in FIGS. 7 and 9 at 25′. Furthermore, the first top face 24 of the first anti-rotation element 22 is inclined relative to the planar end face 16 of the annular flange 14 sloping downwardly (as oriented in FIGS. 7 and 9) toward the central pilot portion 12. Each of the first anti-rotation elements 22 also includes opposing side walls 34 (see FIG. 5) that are angled so that each of the first anti-rotation elements 22 defines a trapezoidal cross-section. The trapezoidal cross-section provides die relief when removing the self-attaching nut 10 from the forming die.

The first top face 24 defines an angle with the generally planar end face 16 of between about 18 degrees and about 22 degrees. In an example of the present disclosure, the first top face 24 defines an angle with the generally planar end face 16 of about 20 degrees. The second top face 28 defines an angle with the generally planar end face 16 of between about 13 degrees and about 17 degrees. In an example, the second top face 28 may define an angle with the generally planar end face 16 of about 15 degrees. In such an example, the ratio between the angle defined between the first top face 24 and the generally planar end face 16 to the angle defined between the second top face 28 and the generally planar end face 16 is between about 1.7 and about 1.1. In an example, the ratio may be about 1.3. The angles and ratios set forth above may provide an optimum metal shell packing toward the undercut 37 to enhance retention of the self-attaching nut 10 to the metal shell 82.

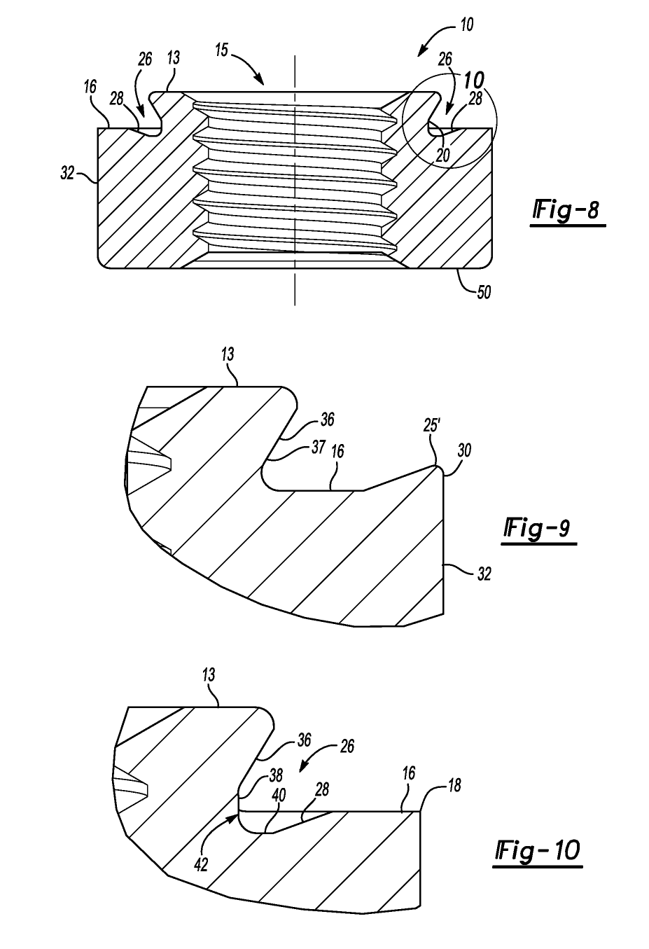

Referring now to FIGS. 8 and 10, each of the second anti-rotation elements 26 extends radially outwardly from the undercut 37 of the central pilot portion 12. As depicted in FIG. 10, the outer side wall 20 of the central pilot portion 12 defines an inclined surface 36 sloping radially inwardly toward a generally vertical surface 38. The generally vertical surface 38 extends downwardly below the planar end face 16 of the annular flange 14 at the second anti-rotation element 26. The second anti-rotation element 26 defines a floor 40 that is spaced below the planar end face 16 and transitions to the second top face 28 of the second anti-rotation element 26. Therefore, the second anti-rotation elements 26 each extend radially outwardly from a base 42 of the central pilot portion 12 that is defined by the generally vertical surface 38. Each of the second anti-rotation elements 26 also extends radially outwardly from beneath the undercut 37 defined by inclined surface 36 at spaced locations to a location spaced from the peripheral edge 18 of the annular flange 14.

Another example is generally shown in FIGS. 11 and 12 at 110 where like elements to the examples depicted in previously described figures are represented in the 100 series for simplicity. The example of the self-attaching nut 110 depicted in FIGS. 11 and 12 includes a central pilot portion 112 and an annular flange 114. The outer radial flange wall 32 (see FIG. 5) is called an outer side wall 120 in the example depicted in FIGS. 11 and 12. The outer side wall 120 is defined by a plurality of flange walls 149 that are generally planar. The outer side wall 120 defines a polygonal shape having a plurality of abutting planar surfaces. In the example depicted in FIGS. 11 and 12, the abutting planar surfaces are eight flange walls 149 that define an octagonal peripheral edge 118 or periphery of the self-attaching nut 110. The first anti-rotation elements 122 are spaced generally centrally upon each flange wall 149, and the second anti-rotation elements 126 oppose an intersection 135 between adjacent flange walls 149. However, in another example, the first anti-rotation elements 122 may be positioned opposing the intersection 135 of adjacent flange walls 149, and the second anti-rotation element 126 may be located generally centrally to each flange wall 149. Alternative geometric shapes may also be selected having more or fewer adjacent flange walls 149 defining, for example, a hexagonal outer side wall 120.

A further example of a self-attaching nut of the present disclosure is shown in FIG. 13 at 210 where like elements to examples depicted in previously described figures are represented in the 200 series for simplicity. This example may have superior attachment characteristics when the metal shell 82 is relatively thick. As depicted in FIG. 13, the central pilot portion 212 is axially elongated away from the annular flange 214. In this example, a cylindrical surface 251 extends downwardly from an upper surface 252 of the central pilot portion 212 toward the annular flange 214. An inclined surface 236 extends radially inwardly from the cylindrical surface 251 defining an undercut 237 at the central pilot portion 212. The inclined surface 236 terminates at the planar end face 216 between each of the second anti-rotation elements 26. The inclined surface 236 terminates at the floor 40 at the second anti-rotation element 26 as depicted in FIG. 10.

FIGS. 14A-14C depict a process for installing a self-attaching nut 10 according to the present disclosure. A portion of a die press 44 is depicted installing a self-attaching nut 10 to a portion of a metal shell 82. In FIG. 14A, the self-attaching nut 10 is received in an installation head 46 in an upper die shoe 48. FIG. 14B depicts a reciprocal plunger 86 of the die press 44 driving the self-attaching nut 10 into contact with the metal shell 82. FIG. 14C depicts the reciprocal plunger 86 pressing the self-attaching nut 10 toward the die button 58 with a force to shear and separate a slug 88 from the metal shell 82. Substantially simultaneously with the shearing of the slug 88, the metal shell 82 is plastically deformed to engage the first and second anti-rotation elements 22, 26 and anti-pulloff features of the self-attaching nut 10 (see FIGS. 17 and 18.)

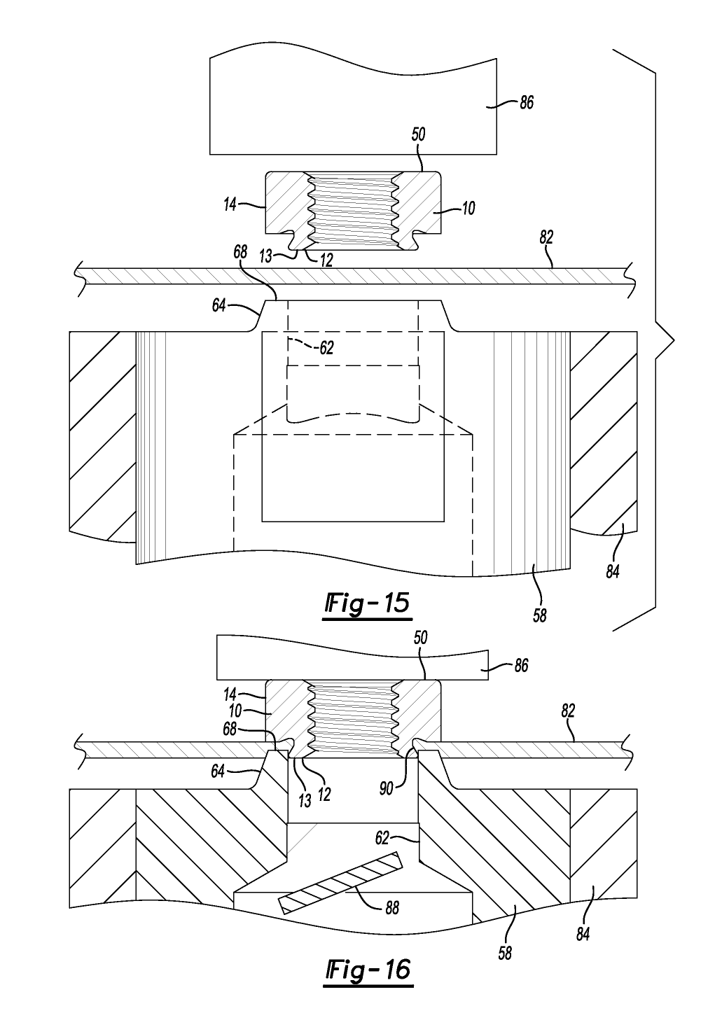

FIG. 15 semi-schematically illustrates the orientation of the self-attaching nut 10 with the die button 58 and a metal shell 82 between the steps shown in FIGS. 14A and 14B. In the example depicted, the die button 58 is located in the lower die shoe 84 of the die press 44 (see FIGS. 14A-C), and self-attaching nuts 10 are fed to and received in the installation head 46 in the upper die shoe 48 having a reciprocal plunger 86. The metal shell 82 may be temporarily fixed relative to the lower die shoe 84, and the reciprocal plunger 86 is driven against the back face 50 of the self-attaching nut 10 through a plunger passage of the installation head 46. FIG. 15 is an exploded view to illustrate the alignment of the self-attaching nut 10 with the die button 58, wherein the central pilot portion 12 is aligned with the opening 62 through the die button 58, and the clinching lip 64 is aligned with the annular flange 14, which is the initial step of the method of installing a self-attaching nut 10 in a metal shell 82 according to an example of the present disclosure.

In examples in which the self-attaching nut 10 is a pierce nut, the pilot end 13 of the central pilot portion 12 is driven against the metal shell 82, and a slug 88 is pierced from the metal shell 82 by cooperation of the pilot end 13 of the central pilot portion 12 and the end face 68 of the clinching lip 64 as shown in FIG. 16. The aperture 90 formed in the metal shell 82 will therefore be configured to receive the central pilot portion 12 therethrough. The clinching lip 64 is aligned with the annular flange 14 as shown in FIG. 16. Alternatively, where the self-attaching nut 10 is a clinch nut, the aperture 90 through the metal shell 82 is preformed and configured to receive the central pilot portion 12. FIGS. 14A-14B illustrate the sequence of installation of the self-attaching nut 10 in the metal shell 82 as the clinching lip 64 is driven against the metal shell 82 toward the annular flange 14.

As depicted in FIG. 14C, and in FIGS. 17 and 18, continued driving of the clinching lip 64 toward the annular flange 14 deforms a portion 92 of the metal shell 82 against the first anti-rotation elements 22, the second anti-rotation elements 26 (see FIG. 10), and the planar end-face 16 of the annular flange 14. As shown in FIG. 17, the metal shell portion 92 is initially driven against the first top face 24 of the first anti-rotation elements 22. The die press 44 drives the clinching lip 64 of the die button 58 into the metal shell portion 92 against the annular flange 14 with sufficient force to cause extrusion of metal in the metal shell portion 92. Since the first top face 24 of the first anti-rotation element 22 is inclined relative to the planar end face 16 of the annular flange 14 sloping upwardly (as depicted in FIGS. 13 and 14) toward the central pilot portion 12, the metal of the metal shell portion 92 is urged toward the central pilot portion 12 as the metal extrudes. The metal shell portion 92 is then urged by the inclined, second top face 28 of the second anti-rotation element 26 (see FIG. 10) to extrude toward the undercut 37 of the central pilot portion 12. The metal shell portion 92 is deformed inwardly against the undercut 37 of the central pilot portion 12 to prevent the self-attaching nut 10 from pulling off of the metal shell 82. The metal shell portion 92 is also deformed to engage the first and second anti-rotation elements 22, 26 to prevent the self-attaching nut 10 from rotating relative to the metal shell 82.

FIG. 18 is identical to FIG. 17, except that the clinching lip 164 of the die button 158 has a contoured end face 168 including a first inclined end face 196 to follow the contour of the first anti-rotation elements 22 and reduce an amount that the metal shell portion 92 is thinned between the first anti-rotation elements 22 and the clinching lip 164.

In an example of the present disclosure, the self-attaching nut 10 may be a pierce nut as shown in FIG. 16. In another example, the aperture 90 through the metal shell 82 may be preformed, wherein the self-attaching nut 10 is a clinch nut. The end face 68 of the clinching lip 64 may have various configurations which will be dependent in part upon the thickness of the metal shell 82.

It is to be understood that disclosure of any ranges herein is for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, an angle range from about 18 degrees to about 22 degrees should be interpreted to include not only the explicitly recited limits of 18 degrees to 22 degrees, but also to include individual angles such as 19 degrees, 20.1 degrees, etc., and sub-ranges such as from about 18.2 degrees to about 21 degrees, etc. Furthermore, when “about” or “approximately” is utilized to describe a value, this is meant to encompass minor variations (up to +/−10%) from the stated value.

In describing and claiming the examples disclosed herein, the singular forms “a”, “an”, and “the” include plural referents unless the context clearly dictates otherwise.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

While several examples have been described in detail, it will be apparent to those skilled in the art that the disclosed examples may be modified. Therefore, the foregoing description is to be considered non-limiting.

What is claimed is:

1. An exhaust system component for an internal combustion engine, the exhaust system component comprising:
an exhaust gas conduit having a metal shell; and
a boss, crimped to the metal shell;
wherein:
the boss is to threadingly mount an electrical sensor to measure an exhaust gas property; and
the boss includes a self-attaching nut.

2. The component as defined in claim 1 wherein the electrical sensor is a Heated Exhaust Gas Oxygen (HEGO) sensor.

3. The component as defined in claim 1 wherein the exhaust gas conduit is a catalytic converter.

4. The component as defined in claim 1 wherein the exhaust gas conduit is a tubular member.

5. The component as defined in claim 4 wherein the tubular member is connected to a catalytic converter to convey an exhaust gas produced by the internal combustion engine to the catalytic converter or to convey the exhaust gas from the catalytic converter.

6. The component as defined in claim 1 wherein the metal shell defines an aperture having a central pilot portion of the self-attaching nut disposed therein.

7. The component as defined in claim 6 wherein the aperture is defined in a flat land defined on a surface of the metal shell.

8. The component as defined in claim 1 wherein the metal shell defines an aperture having been formed by shearing action of a central pilot portion of the self-attaching nut and a die button positioned against opposed surfaces of the metal shell, the self-attaching nut having been pressed toward the die button with a force to shear and separate a slug from the metal shell.

9. The component as defined in claim 1 wherein the self-attaching nut comprises:
a central pilot portion having an outer side wall being annular;
an annular flange surrounding the central pilot portion, the annular flange having a planar end face defining a peripheral edge with an edge diameter greater than a wall diameter of the outer side wall of the central pilot portion;
the planar end face including a plurality of circumferentially spaced first anti-rotation elements, each of the first anti-rotation elements having a planar first top face spaced above the planar end face of the annular flange, the planar end face further including a plurality of circumferentially spaced second anti-rotation elements, each of the second anti-rotation elements having a planar second top face spaced below the planar end face of the annular flange, one of the plurality of first anti-rotation elements and the plurality of second anti-rotation elements radially extending from the peripheral edge of the annular flange to a location spaced from the outer side wall of the central pilot portion, the other of the plurality of first anti-rotation elements and the plurality of second anti-rotation elements radially extending from the outer side wall of the central pilot portion to a location spaced from the peripheral edge of the annular flange; and
the first anti-rotation elements circumferentially alternating with the second anti-rotation elements.

10. The component as defined in claim 9 wherein the first anti-rotation elements extend radially inwardly toward the central pilot portion from the peripheral edge of the planar end face.

11. The component as defined in claim 9 wherein each of the first top faces of the first anti-rotation elements and the second top faces of the second anti-rotation elements is inclined relative to the planar end face of the annular flange.

12. The component as defined in claim 9 wherein the first anti-rotation elements define a trapezoidal cross-section.

13. The component as defined in claim 9 wherein the annular flange defines an outer radial flange wall, and the first anti-rotation elements each define a distal wall aligned with the outer radial flange wall.

14. The component as defined in claim 13 wherein the outer radial flange wall defines a polygonal shape comprising a plurality of abutting planar surfaces.

15. The component as defined in claim 14 wherein each of the first anti-rotation elements is aligned generally centrally with one of the abutting planar surfaces.

16. The component as defined in claim 9 wherein the second anti-rotation elements extend radially outwardly from a base of the central pilot portion.

17. The component as defined in claim 9 wherein the central pilot portion defines an undercut, and the second anti-rotation elements extend radially outwardly from beneath the undercut upwardly to a location spaced from the edge of the annular flange.

18. The component as defined in claim 9 wherein the central pilot portion defines a pilot end and an inclined surface, the inclined surface being spaced from the pilot end.

19. The component as defined in claim 9 wherein the central pilot portion defines a pilot end and an inclined surface spaced from the pilot end by a cylindrical surface.

20. The component as defined in claim 9 wherein a ratio between an angle defined between the first top face and the planar end face to an angle defined between the second top face and the planar end face is between about 1.7 and 1.1.

21. The component as defined in claim 20 wherein the ratio is about 1.3.
